(19) United States
(12) Patent Application Publication
(10) Pub. No.: US 2017/0023694 A1
(43) Pub. Date: Jan. 26, 2017

(54) APPARATUS FOR AIRBORNE AND GROUND ELECTROMAGNETIC PROSPECTING AND METHOD THEREOF

(71) Applicant: Advanced Electromagnetic Technologies, Laval (CA)

(72) Inventor: José Manuel MARTINEZ ORTEGA, Laval (CA)

(21) Appl. No.: 15/218,372

(22) Filed: Jul. 25, 2016

Related U.S. Application Data
(60) Provisional application No. 62/195,958, filed on Jul. 23, 2015.

(51) Int. Cl. G01V 3/165; G01V 3/38; G01V 3/16

(52) U.S. Cl. CPC G01V 3/165; G01V 3/16; G01V 3/38

(57) ABSTRACT

There is described an improvement of the signal-to-noise ratio of an airborne/ground time-domain electromagnetic apparatus and a measuring/interpretation method for the voltage signal recorded. The system comprises: at least one embedded transmitter-receiver structure with at least one large receiver element allowing low system base frequency excitation and discrimination of targets at depths of at least 1 km; wherein the receiver element is positioned throughout the electromagnetic cavity created by transmitter elements whereas no bucking or suspension means are required; a computer network comprising: a microprocessor, a controller from the microprocessor and a host computer controls transmission of primary magnetic field intensities and reception of secondary magnetic field intensities with least 500 kS/s. A method of interpreting of the voltage recorded by receivers elements based on new sensitivity magnetic kernels is disclosed. The fabrication process the apparatus serving for airborne or ground electromagnetic surveying is disclosed.

### CROSS-REFERENCE TO RELATED APPLICATION

This application claims priority from US provisional patent application U.S. 62/195,958 filed Jul. 23, 2015, the specification of which is hereby incorporated herein by reference in its entirety.

### FIELD

This disclosure relates in general to the field of airborne and ground electromagnetic surveying. This disclosure further relates to a system and apparatus for conducting time-domain electromagnetic surveys using an airborne or ground vehicle. More specifically, but not by way of limitation, this disclosure relates to improved systems and methods for acquiring and interpreting time domain electromagnetic responses that allow shallow- and deep-conductive targets to be classified with greater precision.

### BACKGROUND

To reduce the cost of airborne electromagnetic survey's operation it is desirable to use a compact and light airborne electromagnetic system in order to carry out surveys, for instance, at speeds greater than 100 km/h. At such high speeds to avoid degradation of the SNR, the lateral resolution (distance between consecutive measurements) should be increased to have more transients on average. The number of transients depends linearly on the system base frequency f_{b} and the lateral resolution, d and inversely with respect to the speed of the helicopter, vₕ. The number of samples in one transient is ultimately determined by the system sampling rate, S_{R}. The nature of the impulsive electromagnetic system is that once the primary field is switched off, the signal will decay rapidly into the noise and, the more data points are sampled, a further improvement of the system SNR is guaranteed.

High SR is desirable for detection of deep as well as high conductivity targets where the signal falls off into the noise rapidly. In some airborne EM system due to poor SR and long ramp-off time (the time the system takes to completely cut off the pulse of current) deep, shallow and highly conductive targets are not identified precisely. Therefore having a time domain electromagnetic apparatus with high SR allowing fast sampling and short ramp off time is one of most wanted technological features for ground or airborne electromagnetic systems.

A high SNR is desirable for an EM apparatus because it determines the ability of the system to discriminate deep seated targets at depths beyond one km with high spatial resolution vertically and laterally. To discriminate targets at such depths the apparatus must be complemented with a method of measuring and interpreting the voltage recorded as a function of actual target characteristics (depth, size, geometrical shape, conductance, etc.). Further enhancement of the voltage recorded is possible by removing the primary field generated by transmission from the signal such that the only contribution remaining to the voltage recorded is due to the secondary anomalous field arising from conductive targets. This fact will be transparent from the description of the present invention.

The physics rationality for the design of a time domain electromagnetic systems are based on the seminal works done by: Kaufman (Kaufman, A. A., 1965, Theory of induction logging: Nauka, Siberian Division, Acad. Sci. U.S S.R); Wait (Wait J. R., Electromagnetic waves in stratified media, 2nd ed. Oxford: Pergamon, Press 1970); Riche (Raiche, A. P., 1974. An integral equation approach to three-dimensional modeling, Geophys, J. R. Astr. Soc., 36, 363-376.); and Hohman (Hohman, G. W.: 1975. ‘Three-Dimensional Induced-Polarization and Electromagnetic Modeling’, Geophysics 40, 309-324).

These early studies established first models to determine the voltage (or its sum) induced at receiver clips (or sometimes referred as impulse and step responses) over simplified Earth-like geometries (plates, layers, spheres, and cylinders), which led to three well-known transmission-reception interpretation methods: (1) Rx at the center of the Tx (central loop), Rx outside the Tx (offset loop) and Tx as both transmitting and receiver means (coincident loop). The main difference between these interpretation methods is the way system performs measurements of secondary fields at receivers while in the presence of high magnetic field intensity imposed by the transmitter. That is the primary magnetic field intensity, Hp [A/m] generated by the Tx needs to be cancelled (or sometimes referred as bucking mechanisms) to avoid saturation of Rx.

A type of central loop configuration like the vTEM system operated by GEOTECH LTD disclosed in U.S. Pat. Nos. 7,157,914, 7,948,237, 8,400,157, 8,674,701, and 8,766,640 is such that both Tx and Rx are coplanar and the receiver is positioned at the center of the Tx. The physics rationality of this measuring method obeys to the fact that, for a circular coil, the minimum magnetic induction field generated by the Tx-loop is found at the center of it. Due to the fact that Rx is not a point source, but has physical dimensions, the lines of primary magnetic induction field impinge the Rx and therefore this central loop configuration requires another coil known as a bucking coil which is concentric and coplanar with Tx to efficiently cancel out Hp as disclosed in U.S. Pat. No. 5,557,206. Then, by connecting the Tx and Bx in series and reversing the polarity on the latter, it is possible to create an almost instantaneous secondary field cancelling out the Hp at the center of the Tx-Bx-Rx arrangement. This type of measuring platform is disadvantageous as the proposed bucking mechanism diminishes the moment of the system as the current imposed in right on the Bx-loop opposes to the changes of primary current driven in the Tx-loop.

This semi-rigid structure solved deficiencies related in an earlier disclosure of U.S. patent application Ser. No. 10/378,850 regarding to excessive weights, vibrations and SNR improvements. A semi-rigid structure is needed to maintain symmetrically, and almost around the same plane, the Tx-Bx-Rx arrangement. The need for supporting structures for the Tx, Bx and Rx increases the weight and air drag forcing the system to fly at lower speeds. The arrangement is interconnected by a set of ropes, and vibrations from the Tx and Bx are imparted onto the Rx raising the unwanted microphonic noises. A well balanced and controlled suspension system helps to minimize vibrations and orientation of receiver coils as disclosed in U.S. Pat. No. 8,878,538. For this type of measuring platform, the system sampling rate ranges from 100 kS/s (kilo-samples per second) to 200 kS/s as disclosed in the U.S. Pat. No. 8,400,157.

Another central loop configuration for an airborne EM sounding apparatus was disclosed in international patent application no. WO2014026275. The noise produced by high frequency vibrations onto the Rx were attenuated by a configurable rigid suspension assembly connected to Tx's supporting structure. The signal strength of the system can be improved by increasing the size of Rx, however the larger it becomes the heavier and bulky the suspension assembly is. The system sampling rates according to public surveys reports (http://www.geologyontario.mndmf.gov.on.ca/mndmfiles/afri/data/imaging/2000000 2752//20004275.pdf) can be determined using the point value reported of 10.85 ρs, yielding to 1000 ms/10.85 ρs˜92 kS/s.

The measuring platform for offset loop configurations is advantageous as the Bx is not needed. However, this may result in an increase the overall weight of the system since the Rx is placed along the vertical or at certain distance parallel to the transmitter loop. Of course, the bigger the separation between the Tx and the Rx, the minimal is the influence of Hp on measurements. However, this improvement comes with the difficulty of making the system heavier as somehow the Tx and Rx need to be connected in a rigid or semi-rigid structure. If the receiver is Rx placed at some distance above the Tx loop along the vertical, a degradation of the SNR is expected as the secondary magnetic field intensities decay as the inverse of cubic distances (considering a dipolar source of current). Horizontal separation is more advantageous (see for instance international patent No. WO 2005106536); however, maintaining the height of the bird at relative constant altitude, small coils used, plus air drags the system is subjected to, may deteriorate the system's SNR.

Another offset loop configuration is the SkyTEM operated SkyTEM Surveys ApS exhibiting a compact design. This was disclosed in the international patent application no. WO2004072684. A set of Rx were positioned in the nearby zone of the transmitter coil elements. The positioning of Rx's was such that they were tangent to the primary magnetic field induction lines to achieve minimal influence of the primary field into the signal being detected. The control of the current imposed to the Tx allows quick turning off of the pulse of current and as consequence near surface measurements with high spatial resolution can be conducted. Measurements at depths are accomplished with large transmitter coil elements and accompanied with fine noise reduction techniques applying synchronous detection measuring scheme to the local noise conditions as disclosed in the peer reviewed publication by N S Nyboe and K. Sørensen “Noise reduction in TEM: Presenting a bandwidth- and sensitivity-optimized parallel recording setup and methods for adaptive synchronous detection,” Geophys. 77, E203-E212, 2012. Yet, the signal strength may be limited because of small size of receiver. The high control of the noises and processing techniques presented the system allows a good discrimination of targets. According to public records the latest version of the system skytem312FAST (e.g. http://skytem.com/skytem312-fast/) has a sampling rate of 150 kS/s. The disadvantage of this recording configuration is clear, the system is not able to measure the voltage at the receiver by the primary field and the full spectrum recording is not possible. Another disadvantage is the limited size of receiver coils and therefore a limited SNR.

The coincident loop configuration fails as a measuring apparatus since it requires the Tx working as both transmitting and receiver means. In practice, the electro-mechanical design of such apparatus is not possible due the fact that the total inductance (self+mutual) of the Tx differs substantially from that of the Rx. For instance, an optimum design of Tx requires a high gauge wire to withstand high pulse of currents (˜several hundred Amperes) with a minimal inductance (for fast current cut off); whereas for Rx thinner wire gauges and a very compact winding is needed to have the highest inductance possible to detect weak time varying voltages (1 nV/s˜ ranges).

One possible solution for the central loop configuration would be to use a set of smaller receiver coils and connect them in series and place them in such a way that they are slightly sensitive or almost not sensitive to the primary field. This type of airborne time domain apparatus was disclosed in Canadian patent application No. 2739630. The apparatus used small gauge wire for the transmitter means which resulted in a high inductance therefore, for fast turning-off of the primary pulse, an extra current injector was necessary. The control of a power source with several current injectors added more complexity to the transmission. In addition, the need for supporting structure to maintain the rigidity and separation between Tx and Rx is still needed.

While existing airborne EM systems are well-suited to identify the presence of a conductive target the low signal to noise ratio limit them to determine accurately key properties of the target (e.g., high conductance, depth, shape, and orientation) with high spatial resolution at depths beyond 1 km while the survey is conducted at speeds of at least 100 km/h to thereto known.

### SUMMARY

This disclosure relates to three orders of improvement of the signal-to-noise ratio (SNR) of an airborne/ground time-domain electromagnetic apparatus and a measuring/interpretation method for the voltage signal recorded; comprising at least one embedded transmitter-receiver with an inner frame structure and a receiver element at least eight times bigger than hereto known allowing low system base frequency excitation and discrimination of targets at depths of at least 1 km. The receiver element is positioned throughout a tubular electromagnetic cavity created by transmitter elements whereas no extra bucking or suspension element is required making the system lighter and compact to conduct airborne surveys at speeds superior of 100 km/h without degradation of either the spatial resolution or signal-to-noise ratio; a computer network comprising: a microprocessor, a controller connected to the microprocessor and a host computer to control transmission of primary magnetic field intensities and reception of secondary magnetic field intensities with least 500 kS/s. A new interpretation method for deep target discrimination and signal enhancement based on a three dimensional sensitivity function and the full spectrum recorded is also disclosed.

In this disclosure, reference will be made to phrases and terms used of art that will be defined as follows:

Vectors will usually be denoted with boldface uppercase letters and matrices usually with uppercase letters.

Secondary Electric Current (SEC), Jₛ(rₛ,ω): is the macroscopic magnitude obtained by the spatial average of the secondary magnetic field intensities arising from conductive targets at the position rₛ inside the target area having a frequency ω.

Volume Conductor Ωⱼ: is the model assumed for the target region (e.g., thin plate, layered Earth, cylinder, or sphere).

Generating Volume Ω_{g}: the subset of Ωv where the SEC originates (e.g., thin plate, layer Earth, cylinder, or sphere).

Lattice of the Volume Conductor, Rv: the discrete group of Nv points rᵥεΩv.

Lattice of the Generating Volume, R_{g}: the discrete group of N_{g} points r_{g}εΩg.

IPHC, is a type of volume conductor referred as Isotropic Piece-wise Volume Conductor used to model the target area.

Tx is the load of a high power circuitry composed of a set conductive bars (cables).

Rx is a set of electromagnetic induction magnetometers designed to detect weak and secondary electromagnetic induction fields (e.g., dB/dt or B).

Hp is the primary magnetic field intensity in A/m generated by the pulse of current imposed to the Tx.

A time domain electromagnetic (EM) apparatus works by double induction principle, first “injecting” a fast changing primary electric field into the target and secondly recording weak time varying magnetic induction flux. For airborne electromagnetic surveys, the induced electric field is due to a pulse of current superior to 300 A imposed into the transmitter coil hereafter referred as Tx, while voltages (or its sum) are detected by set of electromagnetic magnetometers referred hereafter as Rx, which are spatially oriented along x-, y- and z-directions.

The strength of voltage at receiver clips V_{R}_{_{X}}(ω) (or its sum) depends on the magnitude, direction and the rate of change of the primary magnetic field intensity, Hp in [A/m] as well as from the superposition of all scattered or anomalous electric fields arising from the ground at boundaries with high conductivity contrast. Because of the Rx are not point sources or ideal detectors, their design is key to increase the signal-to-noise ratio (SNR) and discriminate the signal being detected from atmospheric-, geological- and instrumentation-noises.

According to an aspect, there is provided a measuring and interpreting method to calculates the magnetic sensitivity functions that establish a model that relates the observed data V_{R}_{_{X}}(ω) to the quantity for estimating secondary electric current (SEC). This model is known as the Direct Problem.

According to another aspect, the apparatus is a coincident Tx-Rx arrangement where an arrangement of transmitting elements are such that upon imposing a pulse of current, the summation of all the flux of Hp are cancelled inside the transmitter arrangements and maximized outside of the arrangement. This transmitter arrangement forms a true coincident Tx-loop and it is composed of a set of conductive elements with an embedded receiver element equidistant from an even number of radially positioned conductive elements such that when the current is circulating through conductive elements, it creates a magnetic cavity of tubular shape throughout the center of the Tx arrangement. This apparatus is advantageous as the same Tx-loop works as the bucking mechanism and there is no need for bucking coils being more compact to those hitherto known.

According to another aspect, the apparatus is composed by an inner frame-structure with supporting the true coincident transmitter-receiver loop configuration. It is a measuring time domain electromagnetic apparatus for airborne or ground surveys with straight blocks and/or transmitter spacers as well as corner blocks which are light weight supporting structures.

According to another aspect, the apparatus is a large air core induction magnetometer receiver, at least eight meters wide, with low corner frequency of 1 Hz and high corner frequency of 200 kHz.

According to another aspect, the apparatus that the system controls is embodied in a high speed data acquisition network connecting a microprocessor, a controller of the former and a host computer with a sampling rate of at least 500 kS/s per half cycle faster to hitherto known.

According to another aspect, the apparatus comprises a new set of kernels for the voltage recorded at the receiver's clips is determined by two contributions: one due to primary field imposed by the transmitter and a second contribution raising whenever the target present areas with high conductance (conductivity×thickness). By removing the transmitter contribution to the recorded signal the SNR is also improved.

According to an embodiment, there is provided a system for electromagnetic prospecting comprising: transmitter coil elements configured to create a magnetic cavity upon transmission of primary magnetic fields from the transmitter coil elements; and a receiver coil element configured to detect secondary magnetic fields, wherein the receiver coil element is positioned substantially at the center of the transmitter coil elements where the magnetic cavity is created.

According to an aspect, the transmitter coil elements each comprise an even number of conductive bar elements which are radially and equidistantly distributed about the receiver coil element.

According to an aspect, the conductive bar elements form a path formed by loop segments.

According to an aspect, the system further comprises non-conductive block elements wherein the loop segments are fixed to the non-conductive block elements and wherein each one of the conductive bar elements is positioned equidistant from the center of the non-conductive block elements.

According to an aspect, the non-conductive block elements comprise either one of a straight block arrangement or a corner block arrangement and the loop segments comprise straight portions and corner portions, wherein the straight block arrangement is configured for maintaining the conductive bar elements equidistant in the straight portions and the corner block arrangement is configured for maintaining the conductive bar elements equidistant in the corner portions.

According to an aspect, the non-conductive block elements have an upper section, a middle section, and a bottom section secured together, wherein the upper section comprises a hook for connecting to a towing cable and the middle section comprises a groove for receiving the receiver coil element.

According to an aspect, the system further comprises at least one of a set of balloon wheels, skis or floats attached to the bottom section of the corner block arrangement.

According to an aspect, the non-conductive block elements are made from ultra high molecular weight polyethylene.

According to an aspect, the system further comprises an inner frame structure and at least one of a set of balloon wheels, skis or floats attached to the inner frame structure.

According to an aspect, the receiver coil element comprises a flexible air core inductor magnetometer receiver coil element and a shielding element surrounding the flexible air core inductor magnetometer receiver coil element.

According to an aspect, the flexible air core inductor magnetometer receiver coil element comprises an induction coil made of solid wires or Litz wires.

According to an aspect, the shielding element comprises thin sheets of conductive material.

According to an aspect, the system further comprises non-conductive block elements, wherein the transmitter coil elements each comprise an even number of conductive bar elements which are radially and equidistantly distributed about the receiver coil element, wherein the conductive bar elements form a path formed by loop segments, wherein the loop segments are fixed to the non-conductive block elements, wherein each one of the conductive bar elements is positioned equidistant from the center of the non-conductive block elements, and wherein the flexible air core inductor magnetometer receiver coil element comprises a cable held at the center of the non-conductive block elements and concentric to loop segments.

According to an aspect, the system further comprises damping viscoelastic foam and an non-conductive tube, wherein the flexible air core inductor magnetometer receiver coil element is wrapped with damping viscoelastic foam and encapsulated inside an non-conductive tube.

According to an aspect, the flexible air core inductor magnetometer receiver coil element operates defines an antenna which is optimized for one of an impedance, a bandwidth and a noise floor.

According to an aspect, the system further comprises a data acquisition system configured for transmitting the primary magnetic fields from the transmitter coil elements and for recording voltages induced by secondary magnetic fields from ground formations in a target area.

According to an aspect, the data acquisition system is further configured for interpreting a signal based on a calculation of magnetic sensitivity kernels that produce measurements at the receiver coil element due to secondary electric fields Jₛ(r,ω) raised in any part of the target area by the secondary magnetic fields.

According to an aspect, the data acquisition system is connected to the receiver coil element and to the transmitter coil elements, wherein the data acquisition system is triggered by a clocked pulse from an external GPS signal.

According to an aspect, the data acquisition system comprises a machine readable storage medium having stored thereon a computer program having code sections, the code sections executable by the data acquisition system to perform at least one of the steps of:
triggering at least one pulse sequence controlled by a microprocessor with at least one microsecond of precision;
controlling a current pulse sequence, wherein the current pulse is a monophasic or biphasic square pulse of current of at least 300 A and lasting at least 2 milliseconds; and
acquiring and transmitting data at a speed of least 500,000 samples per second for recording both primary and secondary fields detected by the receiver coil element.

According to an aspect, the code sections further cause the data acquisition system to perform a computation of magnetic sensitivity kernels which is calculated by a vector boundary element method that comprises the steps of:
specifying positions r_{g} and rᵥ in a lattice of a generating volume R_{g} and of a volume conductor Rᵥ;
specifying a conductivity profile using an approximation such that each set of layers constitutes a collection of N embedded regions for which a conductivity value is constant, σ={σ₁, . . . , Σ_{N}};
calculating numerically values for electric field E_{kV}(ω)=Eₖ(ω,rᵥ) on each rᵥ of the lattice of the volume conductor Rᵥ that belongs to surfaces limiting the embedded regions by means of linear algebraic systems of equations as:

DE(ω)=E_{N∞}(ω)−ME(ω)

wherein E_{N∞}(ω)=(E_{1∞}, E_{2∞}, . . . , E_{N∞})^{t} and E(ω)=(E₁, E₂, . . . , E_{k,k+1})^{t}; N_{k,k+1} is a number point rᵥ that belongs to a specific one of the surfaces separating the embedded regions k and k+1, wherein matrices M and D are being defined as:

$$M = \frac{1}{4 π} [ \begin{matrix}\frac{( {σ}_{2} - {σ}_{1} )}{{σ}_{2}} {H}_{11} & \frac{( {σ}_{3} - {σ}_{2} )}{{σ}_{3}} {H}_{12} & … & \frac{( {σ}_{N} - {σ}_{N - 1} )}{{σ}_{N}} {H}_{1 N - 1} & {Γ}_{1 N} \\ \frac{( {σ}_{2} - {σ}_{1} )}{{σ}_{2}} {H}_{12} & \frac{( {σ}_{3} - {σ}_{2} )}{{σ}_{3}} {H}_{22} & … & \frac{( {σ}_{N} - {σ}_{N - 1} )}{{σ}_{N}} {H}_{2 N - 1} & {Γ}_{2 N} \\ ⋮ & ⋮ & ⋮ & ⋮ & ⋮ \\ \frac{( {σ}_{2} - {σ}_{1} )}{{σ}_{2}} {H}_{1 N} & \frac{( {σ}_{3} - {σ}_{2} )}{{σ}_{3}} {H}_{2 N} & & \frac{( {σ}_{N} - {σ}_{N - 1} )}{{σ}_{N}} {H}_{NN - 1} & {Γ}_{NN}\end{matrix} ]$$

$$D = [ \begin{matrix}{α}_{1} {I}_{{N}_{1 , 2}} & & 0 \\ 0 & & 0 \\ 0 & ⋱ & 0 \\ ⋮ & & 0 \\ 0 & & {α}_{N} {I}_{{N}_{N , N}}\end{matrix} ]$$

$$where \text{:} {α}_{j} = \{ \begin{matrix}\frac{( 2 {σ}_{j + 1} + {σ}_{j} )}{3 {σ}_{j + 1}} & j \neq N \\ \frac{7}{6} & j = N\end{matrix} \\ and \\ {Γ}_{jk} = ( \begin{matrix}{Γ}_{1}^{k} ( {r}_{1}^{j} ) & … & {Γ}_{{N}_{k , k + 1}}^{k} ( {r}_{1}^{j} ) \\ ⋮ & ⋱ & ⋮ \\ {Γ}_{1}^{k} ( {r}_{{N}_{j , j + 1}}^{j} ) & … & {Γ}_{{N}_{k , k + 1}}^{k} ( {r}_{{N}_{j , j + 1}}^{j} )\end{matrix} )$$

rᵢ^{j} labels an i-th point of Rv that belongs to the j-th embedded surface; wherein magnitudes E_{N∞}(ω) are evaluated from expressions expressed as:

$${E}_{N ∞} ( r , ω ) = - \frac{i {ωμ}_{0}}{4 π} {\sum }_{n = 1}^{{N}_{N , N + 1}} {n}_{n} \times {H}_{p} \cdot {ℒ}_{n} ( r )$$

wherein Hₚ is a primary magnetic field generated by a Tx coil
with:

$${ℒ}_{n} ( r ) = {\int }_{{Δ}_{n}^{N}} \frac{dr}{\vert r - {r}^{′} \vert}$$

calculating a magnetic sensitivity kernel in each compartment of E(r) an IPHC by using a reciprocity theorem expressed as:

$${S}_{j} ( r ) = - \frac{1}{{N}_{{T}_{x}} {I}_{TX}} {E}_{j}^{p} ( r )$$

where Eⱼ^{p}(r) is given by:

$$4 π {E}_{j}^{p} ( {r}_{s} ) = 4 π {E}_{∞} ( {r}_{s} , ω ) + {\sum }_{k = 1}^{N - 1} \frac{( {σ}_{k + 1} - {σ}_{k} )}{{σ}_{k + 1}} {\sum }_{n = 1}^{{N}_{k , k + 1}} {M}_{n}^{k} ( {r}_{s} ) {E}_{est}^{k}$$

$$and$$

$${E}_{est}^{k} = {( D + M )}^{- 1} {E}_{∞ N} .$$

These and other advantages and features of the present embodiments will become apparent, and the nature thereof may be more clearly understood by reference to the following detailed description, the claims, and the drawings appended hereto.

### BRIEF DESCRIPTION OF THE DRAWINGS

The description of the illustrative embodiments can be read in conjunction with the accompanying figures. It will be appreciated that for simplicity and clarity of illustration, elements illustrated in the figures have not necessarily been drawn to scale. For example, the dimensions of some of the elements are exaggerated relative to other elements. Embodiments incorporating teachings of the present disclosure are shown and described with respect to the Figures presented herein, in which:

FIG. 1 is a schematic diagram showing an overview of the new time-domain electromagnetic measurement based on the principle of magnetic reciprocity. The latter transforms the problem of integration of secondary responses through the receiver coil by a reciprocal integration throughout all secondary anomalous current sources embedded in the target;

FIG. 2 is a schematic diagram showing an embodiment for the general model for the Earth (target) as a homogeneous isotropic piece-wise volume conductor (IPHC) of arbitrary shape and an arbitrary transmitter coil configuration;

FIG. 3 is a simulation of the cross section of the magnetic cavity created by four symmetrical transmitter coil elements according to an embodiment. An even number of the transmitter elements are symmetrically positioned with respect to the center and equidistant from it. A tubular magnetic cavity is created along the center of transmitter elements by passing a pulse of current with the same direction into all transmitter elements; therefore the lines of magnetic flux are cancel out at the center of the transmitter arrangement;

FIG. 4 is a perspective view of embodiments of the time domain electromagnetic apparatus of a true coincident loop configuration where the receiver coil is embedded within the transmitter coil elements according to an embodiment towed by ground vehicle (A) and airborne (B);

FIG. 5 is a perspective view of sections of the straight-block assembly and the spacer assembly according to an embodiment;

FIG. 6 is a perspective view of the corner block assembly according to an embodiment;

FIG. 7 is a perspective view of a large flexible induction air core flexible receiver coil and positioning within the Tx arrangement according to an embodiment;

FIG. 8 is a schematic diagram showing the network connecting and controlling the transmission of a primary field and reception of secondary fields; and

FIG. 9 is snapshot of field tests collected with an oscilloscope upon firing the system at 500V/100 A at a base frequency of 30 Hz.

### DETAILED DESCRIPTION

The classical expression of the signal-to-noise ratio of a high sensitive air-core magnetometer is determined as follows (see K P. Estola and J. Malmivuo “Air-core induction-coil magnetometer design,” J. Phys. E: Sci. Instrum., Vol. 15, 1982):

$$SNR = \frac{1}{\sqrt{2}} \frac{\frac{\partial }{\partial t} {\sum }_{i = 1}^{{N}_{T}} {φ}_{i}}{Z \sqrt{{i}_{in}^{2}}} , \\ where \frac{\partial }{\partial t} {\sum }_{i = 1}^{{N}_{T}} {φ}_{i} = {V}_{{R}_{X}} ( ω ) \qquad ( 1 )$$

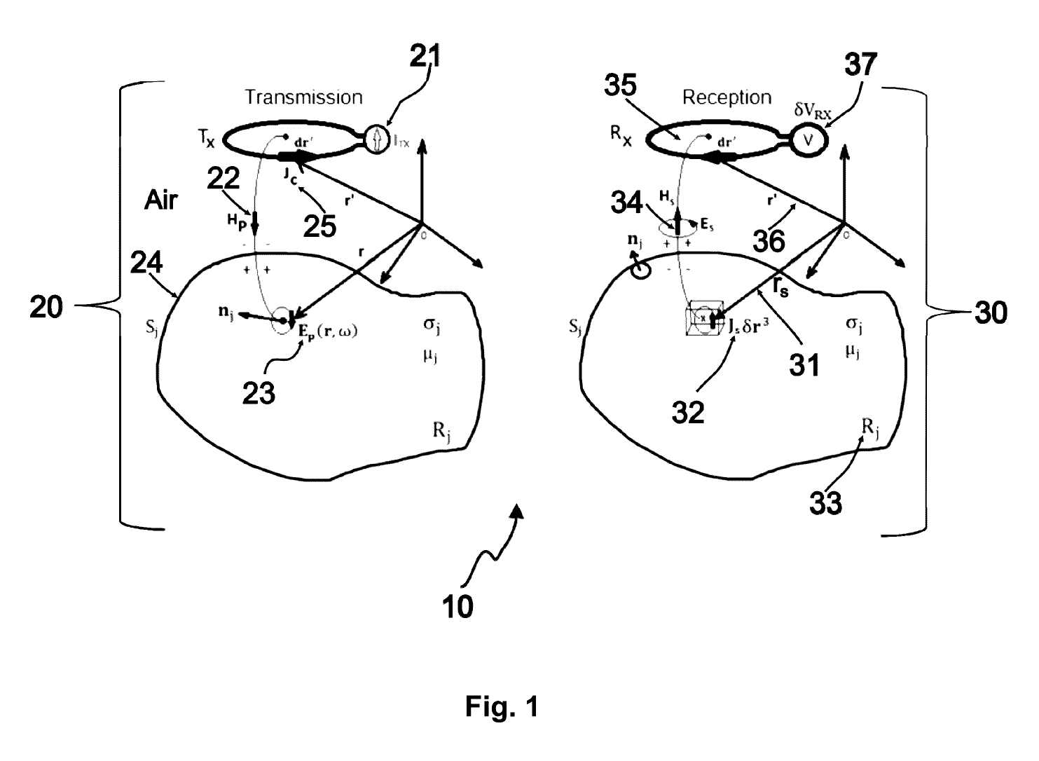

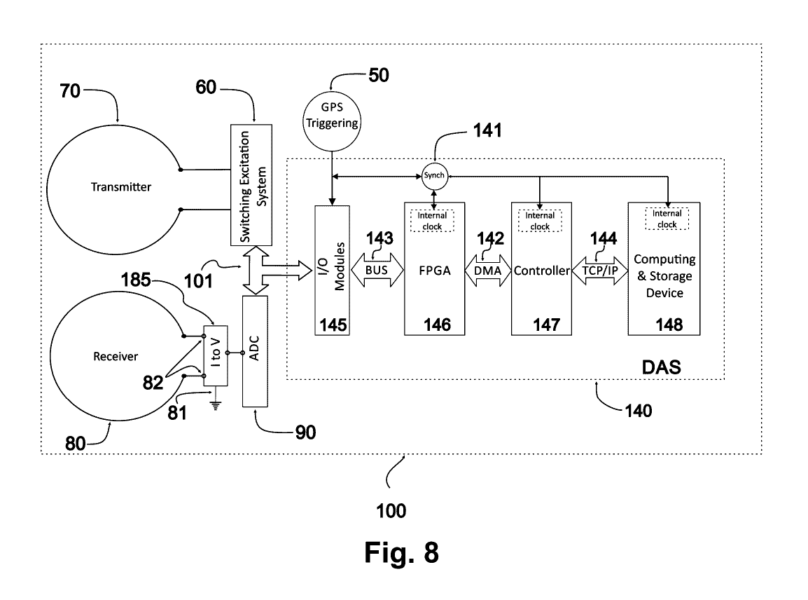

is the voltage measured at Rx clips (see Rx clips 37 FIG. 1 and Rx clips 82 in FIG. 8) and is the superposition of all magnetic fluxes being detected by i-th turn due to an ac electric current, Jₛ(rₛ,ω) herein referred as secondary electric current (SEC) at a point rₛ inside the target area (see FIG. 1). The symbols Z and iᵢₙ² stand for the impedance of the Rx and the equivalent current noise of the amplifier, respectively. The rationale of using large air-core receiver coils as opposed to high permeability core coils (e.g., U.S. Pat. No. 7,375,529 B2) resides on the linearity of the voltage obtained at receiver clips 37, 82. Rewriting equation (1) to account for total number of measurements=number of transients, Nₜ times the number of samples, Nₛ acquired per half cycle, yields:

$$SNR = \frac{1}{\sqrt{2}} \frac{\sqrt{{N}_{t} {N}_{s}} {V}_{{R}_{X}} ( ω )}{Z \sqrt{{i}_{in}^{2}}} , \\ where \text{:} {N}_{t} = \frac{2 {f}_{b}}{{f}_{samp}} = and {N}_{s} = \frac{{S}_{R}}{2 {f}_{b}} ; with {f}_{b} , {f}_{samp} , \qquad ( 2 )$$

S_{R} are the system base frequency, the survey sampling frequency and the system sampling rate, respectively. The sampling frequency is set according to the desired lateral resolution of the survey and the speed of the helicopter, i.e.: fₛₐₘₚ=vₕ/d, where d and vₕ are the lateral distance and the helicopter speed, respectively. Thus, the equation (2) yields:

$$SNR = \frac{1}{\sqrt{2}} \frac{\sqrt{\frac{{S}_{R} \cdot d}{{v}_{h}}} {V}_{{R}_{X}} ( ω )}{Z \sqrt{{i}_{in}^{2}}} , \qquad ( 3 )$$

Equation (3) is the central formula to determine the SNR of the electromagnetic impulse system towed by a ground or airborne vehicle. All engineering efforts towards optimization depend upon optimization of quantities given in equation (3).

For instance, high SNR can be achieved by having faster data acquisition systems allowing small lateral resolutions while surveying at high speeds (e.g., greater than 100 km/h). The voltage can be further enhanced by designing Rx with a large effective area (i.e., number of turns×area) since the bigger the effective area the more lines of magnetic induction field the Rx is able to capture through its winding; however, this may result in lower SNR if the impedance of the Rx is not optimized first.

Prior art systems adapt the existing general theory (i.e. thin plate, spheres) for interpretation of V_{R}_{_{X}}(ω) to their measuring platforms but they do not have a method of interpreting the signal per se corresponding to the specific aspects of the measuring method and technology being deployed.

Advantageously, an interpretation method that allows to express the voltage at the receiver clips 37, 82 as a superposition of magnetic sensitivity functions which are linear operators that predict the V_{R}_{_{X}}(ω) produced by Jₛ(rₛ,ω) 32 in any part of the target and the frequency ω pertinent to any of the interpreting methods (in-loop, offset-loop, coincident-loop) is disclosed in the accompanying embodiments.

Magnetic sensitivity functions are calculated for the magnetic principle of reciprocity embodied in system 10. This principle establishes a linear relationship between the magnetic sensitive function and the electric field that appears when the receiver is energized with an alternating current I_{TX}(ω). This electric field summarizes all the conductive properties of the target independent of the appearance of SEC. That is, using the reciprocity principle and solving the vector boundary problem of the induced electric field inside, the target (sometimes referred as forward problem) it is possible to express the secondary electric field sensed by the Rx into two independent contributions: the primary electric field and an anomalous scattered electric field appearing at boundaries with conductivity contrast inside the target.

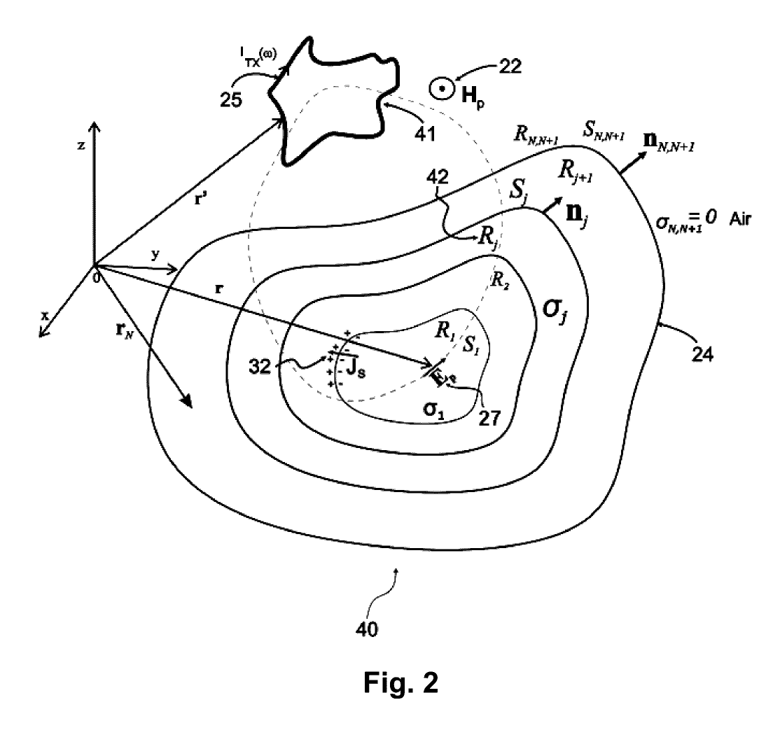

Magnetic theorem of reciprocity rests (e.g., Tai C T 1992 Complementary reciprocity theorems in electromagnetic theory IEEE Trans. Antennas Prop. 40, 675-81): Let δr³ be an element of volume inside the volume Rj. A point source of secondary electric field Jₛ(rₛ, ω)δr³ 32 (see FIG. 2) at the position rₛ inside the conductor, is reflected as an elementary voltage δV(ω) into the Rx clips 37 external to the volume. The former is sort of hypothetical problem and under passive conditions (no charge inside the volume) an alternating current I_{TX}(ω) circulating in the same coil 21 produces a secondary field at the same location. Therefore, the theorem of reciprocity establishes:

Eₛ·J_{c}(r_{c})δr³=Eₚ·Jₛ(rₛ)δr³ (4)

The direct problem postulates how the V_{R}_{_{X}}(ω) are generated from Jₛ(r,ω). This model has two components:
(1) The specific model of Volume Conductor assumed, that is to say, of the conductive properties of the target region (e.g. Earth model), in particular their geometry, conductivity, electric and magnetic permeability, etc.; and
(2) The model that is assumed for Jₛ(rₛ,ω) or source model.

The properties of the volume conductor are summarized in the magnetic sensitivity functions Sⱼ(r). This is a kernel of Fredholm integral equation of the first kind that establishes direct relationships between the Eₛ(r,ω) with V_{R}_{_{X}}(ω):

$${V}_{{R}_{X}} ( ω ) = {\sum }_{j = 1}^{N} {\int }_{{R}_{j}} {S}_{j} ( r , ω ) \cdot {J}_{s} ( r ) d {r}_{j}^{3} \\ where {S}_{j} ( r , ω ) = - \frac{1}{{N}_{{T}_{x}} {I}_{TX}} {E}_{j}^{p} ( r , ω ) \qquad ( 5 )$$

is the magnetic sensitivity function and Eⱼ(r, ω) is the primary electric field induced inside the target due a harmonic time varying alternating current I_{TX}(ω) imposed at the Tₓ having N_{Tx} turns. The coefficient in front of Eⱼ^{p}(r,ω) is commonly referred to as normalization factor applied to the signal recorded. The only assumption needed for derivation of equation (5) is to assume the linearity of the medium regarding to the conductivity and the magnetic permeability. If one assumes that the target is an isotropic homogenous piece wise volume conductor (IPHC) as depicted in the forward problem 40 (see FIG. 2), the primary electric field can be found by the solution of the adjoint problem using the third Green vector identity theorem (e.g. P. M. Morse and H. Feshbach 1953, Method of Theoretical Physics, Part II, Chapter 13, 1768).

The primary induced electric field Eⱼ^{p}(r,ω) 27, 23, in each compartment Rⱼ, 42 for the situation for transmission 20 corresponds to a vector boundary problem and it can be calculated on the basis of the third Green vector formula that takes the form:

$$\begin{matrix}4 π {E}_{j}^{p} ( r ) = 4 π {E}_{∞} ( r , ω ) - {\sum }_{k = 1}^{N - 1} \frac{( {σ}_{k + 1} - {σ}_{k} )}{{σ}_{k + 1}} {∮}_{{S}_{k , k + 1}} ( {∇}^{′} ( r , {r}^{′} ) \cdot {E}_{k} ( {r}^{′} , ω ) \cdot {n}_{k} ( {r}^{′} ) ) d {{r}^{′}}^{2} \\ where \text{:} \\ & ( 6 ) \\ {E}_{∞} ( r , ω ) = - \frac{i {ωμ}_{0}}{4 π} {∮}_{{S}_{N , N + 1}} ( ( r , {r}^{′} ) \cdot [ {n}_{k} ( {r}^{′} ) \times {H}_{∞} ( {r}^{′} , ω ) ] ) d {{r}^{′}}^{2} \\ {r}^{′} ∈ {S}_{N , N + 1} & ( 7 )\end{matrix}$$

Equations (6) and (7) are solved analytically if the symmetry of the IPHC allows a representation in a system of curvilinear coordinates that allows a separation of variables for the solution of the Laplace vector Equation. Otherwise, these expressions should be transformed to Cartesian coordinates and discretized. The discretization over the N-surfaces forming IPHC takes the form of:

$$4 π {E}_{j}^{p} ( r ) = 4 π {E}_{∞} ( r , ω ) + {\sum }_{k = 1}^{N - 1} \frac{( {σ}_{k + 1} - {σ}_{k} )}{{σ}_{k + 1}} {\sum }_{n = 1}^{{N}_{k , k + 1}} {M}_{n}^{k} ( r ) {E}_{est}^{k} , \qquad ( 8 )$$

where: Eₑₛₜ^{k}=(D+M)⁻¹E_{∞N}, with:

DE(ω)=E_{N∞}(ω)−ME(ω) wherein E_{N∞}(ω)=(E_{1∞}, E_{2∞}, . . . , E_{N∞})² and E(ω)=(E₁, E₂, . . . , E_{k,k+1})^{t}; the N_{k,k+1} is a number point rv that belongs to a surface separating the regions k and k+1, wherein matrices M and D are defined as:

$$M = \frac{1}{4 π} [ \begin{matrix}\frac{( {σ}_{2} - {σ}_{1} )}{{σ}_{2}} {H}_{11} & \frac{( {σ}_{3} - {σ}_{2} )}{{σ}_{3}} {H}_{12} & … & \frac{( {σ}_{N} - {σ}_{N - 1} )}{{σ}_{N}} {H}_{1 N - 1} & {Γ}_{1 N} \\ \frac{( {σ}_{2} - {σ}_{1} )}{{σ}_{2}} {H}_{12} & \frac{( {σ}_{3} - {σ}_{2} )}{{σ}_{3}} {H}_{22} & … & \frac{( {σ}_{N} - {σ}_{N - 1} )}{{σ}_{N}} {H}_{2 N - 1} & {Γ}_{2 N} \\ ⋮ & ⋮ & ⋮ & ⋮ & ⋮ \\ \frac{( {σ}_{2} - {σ}_{1} )}{{σ}_{2}} {H}_{1 N} & \frac{( {σ}_{3} - {σ}_{2} )}{{σ}_{3}} {H}_{2 N} & & \frac{( {σ}_{N} - {σ}_{N - 1} )}{{σ}_{N}} {H}_{NN - 1} & {Γ}_{NN}\end{matrix} ]$$

$$D = [ \begin{matrix}{α}_{1} {I}_{{N}_{1 , 2}} & & 0 \\ 0 & & 0 \\ 0 & ⋱ & 0 \\ ⋮ & & 0 \\ 0 & & {α}_{N} {I}_{{N}_{N , N}}\end{matrix} ]$$

$$where \text{:} {α}_{j} = \{ \begin{matrix}\frac{( 2 {σ}_{j + 1} + {σ}_{j} )}{3 {σ}_{j + 1}} & j \neq N \\ \frac{7}{6} & j = N\end{matrix} \\ and \\ {Γ}_{jk} = ( \begin{matrix}{Γ}_{1}^{k} ( {r}_{1}^{j} ) & … & {Γ}_{{N}_{k , k + 1}}^{k} ( {r}_{1}^{j} ) \\ ⋮ & ⋱ & ⋮ \\ {Γ}_{1}^{k} ( {r}_{{N}_{j , j + 1}}^{j} ) & … & {Γ}_{{N}_{k , k + 1}}^{k} ( {r}_{{N}_{j , j + 1}}^{j} )\end{matrix} )$$

with rᵢ^{j} labels an i-th point of Rv that belongs to the j-th surface;

$${E}_{N ∞} ( r , ω ) = - \frac{{iωμ}_{0}}{4 π} {\sum }_{n = 1}^{{N}_{N , N + 1}} {n}_{n} \times {H}_{p} \cdot {ℒ}_{n} ( r ) , \\ where {ℒ}_{n} ( r ) = {\int }_{{Δ}_{n}^{N}} \frac{d r}{\vert r - {r}^{′} \vert} \qquad ( 9 )$$

is the summation of the scalar Green function of the free space over all triangles of the outermost surface of the IPHC. This integral has been calculated analytically for other applications (e.g. J. C. de Munck, 1992, “A linear discretization of the volume conductor boundary integral equation using analytically integrated elements, IEEE Trans. Biomed. Eng. 39, 986-990”); and
wherein E_{N∞}(r, ω) is the contribution to V_{R}_{_{X}}(ω) due to the transmission and it is determined by the summation, over the outermost surface of the transversal component of Hₚ. On the contrary, the second term of equation (6) is an anomalous secondary electric field given by the superposition of all electric fields 32 induced at boundaries with different conductivities presented in the target. The detection of these scattering electric fields 32 is that for which Rx is designed for.

Advantageously, the above interpretation method helps for further enhancement of V_{R}_{_{X}}(ω) by removing the contribution of transmission from the signal recorded, that is E_{N∞}(r,ω), such that only secondary anomalous electric fields (second term of Equation 6 or Equation 8) are the only contributors to the voltage recorded. Removing the primary field from measurements is advantageous because it allows to record the signal coming from the first few meters of the surface and identification of such target with great precision.

The discretization of the terms of equation (8) leads to the following formulation of the direct problem:

v(t)=K·j(t)+e(t) (10)

where K is the Fourier transform of: discretized magnetic sensitivity function and e(t) being the error introduced at the sensors by geological and instrumentation noises.

FIG. 1 is the schematic view of the measuring/interpretation method of coincident loop based on the well-known magnetic reciprocity principle. The transmission 20 is described as following: upon imposing a differential pulse of current 25, a current I_{TX} flows throughout the path closed by coil 21. This current induces a primary magnetic field 22 of an intensity that has a transversal primary electric field 23 associated thereto. This primary electric field 23 will induce a differential primary ohmic current [not shown] at the boundary 24 whenever there is a conductivity contrast. That is an anomalous secondary electric current rise at boundary 24 if and only if the inner boundary Sⱼ₋₁ and outer Sⱼ have different conductivities. This secondary anomalous current will be opposite to the changes of I_{TX} in the transmitter coil elements in a second order of frequency. According to magnetic reciprocity principle this problem is equivalent to the reception of electromagnetic sounding 30. A differential secondary electric field 32 inside the volume 33 and located at location 31 induces a secondary magnetic field intensity in all space 34 that upon crossing the effective area 35 located at 36 will generate a differential voltage along the path closed by receiver clips 37, 82.

In one embodiment, system 10 shows the interpretation method for the voltage induced at receiver clips 37, 82 (see FIG. 8) for the time domain electromagnetic system discussed herein. The voltage recorded of the time domain electromagnetic systems of prior art are not related to its own interpretation method, instead they use a general theory devised for type of measuring method.

FIG. 2 is a schematic of the forward problem 40 or sometimes referred as the adjoint problem for electromagnetic soundings. The most general case is considered where an arbitrary alternating pulse of current I_{TX}(ω) 25 is imposed into an arbitrary configuration of transmitter coils 41.

The physics of transmissions is as follows: once the pulse of current 25 is imposed into an arbitrary configuration of transmitter coils 41 a varying primary magnetic field 22 is generated in the whole space. A transversal primary induced electric field (dotted line) is generated in the whole space and in particular in the inner compartment of the IHPC at Rⱼ 42. An anomalous electric current Jₛ, 32 arises at the boundary where conductivity contrast exists. This electric current arising from the multiple boundaries forming the IHPC is captured by the second term on the right-hand-side of equation (6) and equation (8). This anomalous electric current will oppose to the rate of change to the rate of the magnetic field 22 generated by transmitter coil 41 in a second order of frequency, w.

In one embodiment the model of the ground is an isotropic homogeneous piece-wise volume conductor (IHPC) 40. The volume is composed by a series of nonintersecting regions of any shape for compartment Rⱼ 42 with one being enclosed within another one of larger size with the outermost compartment being the air. The shape of the IHPC can be adapted to a variety of symmetries: spherical-, cylindrical-, and squared of non-intersecting layers or shells.

More specifically the IPHC comprises:
a) The model for the ground compose by N mutually nonintersecting compartments (R₁, R₂, R₃, . . . , R_{N}), where each successive compartment is enclosed in the other, and the exterior compartment is R_{N+1} (air).
b) σⱼ represents the conductivity value of the compartment Rⱼ 42. Note that σ_{N+1}=0.
c) The surface S_{j,j+1} is the boundary separating the inner and outer compartments Rⱼ and Rⱼ₊₁. The vectors nⱼ(r) denote the normal for this surface at the position r. By convention, it is oriented from the inner to the outer compartment.

In one embodiment, system 10 uses a transmitter as receiver and vice versa. However, in practice this is not possible because the physics of these two processes differs. The inductance (self+mutual) required for transmitter coils differs substantially from that of the receiver coils. That is, for transmission, a low inductance Tx coil is needed for fast switching off of the primary field. This is achieved using large wire gauge for the Tx coil. On the contrary, for reception, high inductance coils are required to capture tiny variations of the secondary electric fields 32. Therefore the engineering of transmission coils are quite different from that of receiver coils and the coincident loop configuration failed as a time domain EM apparatus.

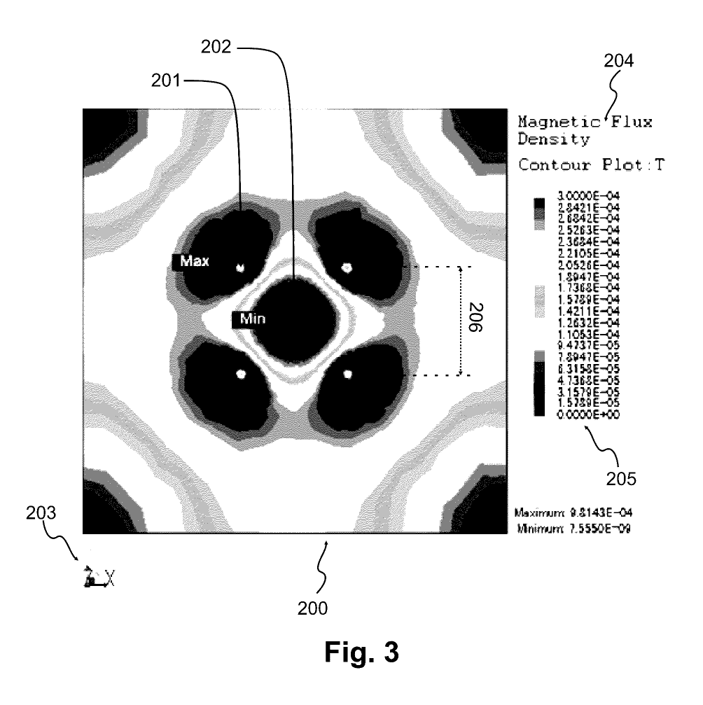

FIG. 3. is the contour plot 205 of the primary magnetic flux density 204 in a plane perpendicular to the direction 203 of the transmitter coil elements when passing the current in the same direction throughout the arrangement of four turns of the transmitter coil elements 201 (respective maximum value of magnetic fields coincides with the respective center of the transmitter coil elements 201). This result confirms a well-known result from the electromagnetism theory where the cancellation of the magnetic induction field lines is achieved at the center of the arrangement due to a symmetrical and parallel placement of conductive elements when the current is circulating in the same direction. This creates a magnetic cavity having a minimum value for the transmitter magnetic fields which substantially coincides with the center 202 of the receiver coil element of a few centimeters in diameter.

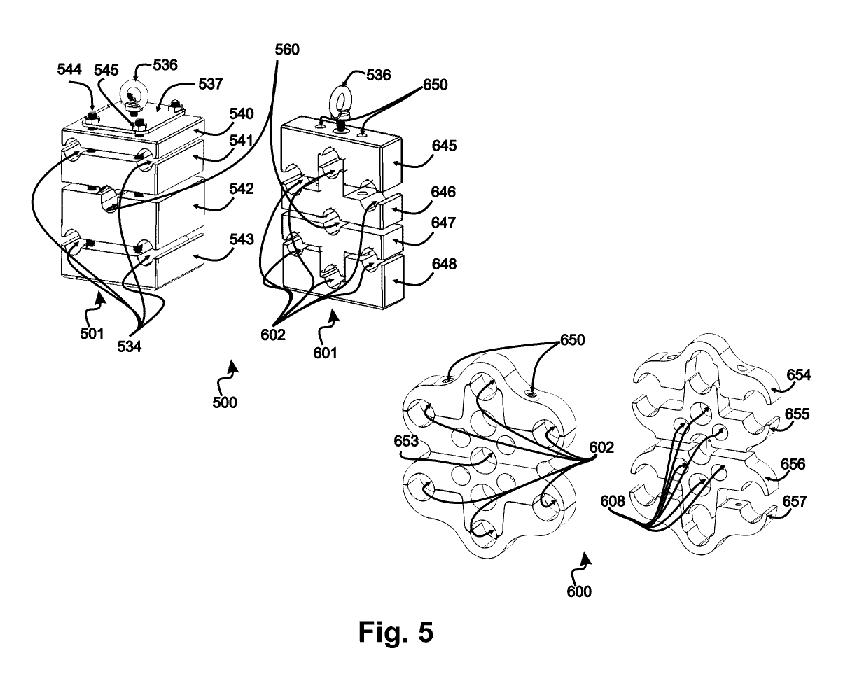

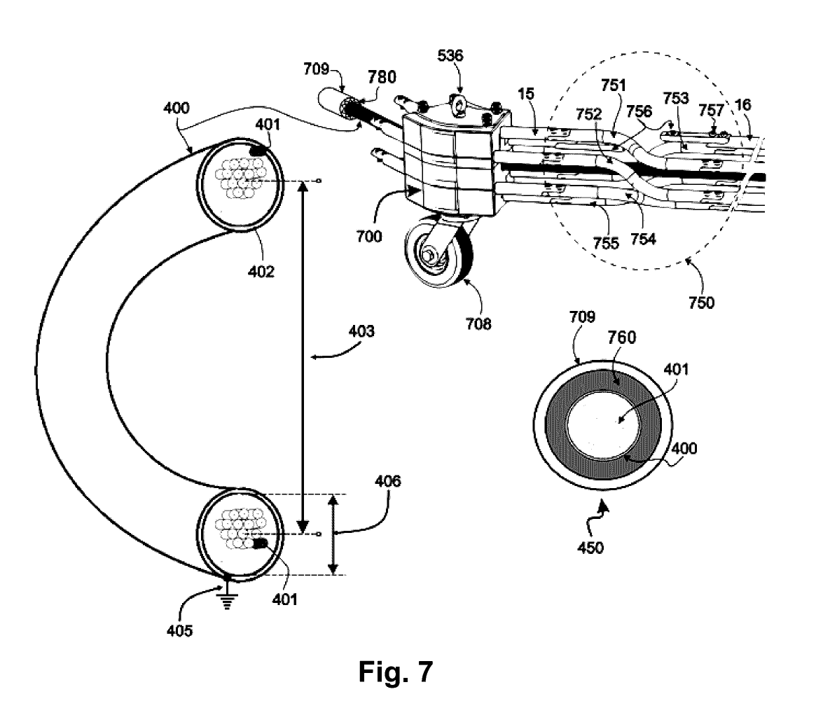

In one embodiment, image 200 shows a cross section of the magnetic flux calculated using a square pulse and a four symmetrically positioned transmitter elements arrangement. Increasing the separation 206 of turns for the transmitter elements will result in a larger magnetic cavity. This is however at the expense of having larger straight blocks 500, 601 (or spacers 600) and corner blocks 570, 700 (see FIGS. 5 & 7 for descriptions of spacers and corner blocks, respectively) resulting in a heavier system; i.e., weights greater than 500 kg are not suitable to carry out time domain airborne time domain EM surveys. Therefore, the separation among turns of transmitter elements and as a consequence, the size of the magnetic cavity is determined by the outer dimension (width 406) of the receiver coil element 400 (see FIG. 7). For people skilled in the art, it will be understood that six turns of the transmitter elements when positioned in the same manner will result in a more homogeneous [not shown] magnetic cavity throughout the arrangement of turns for the transmitter elements.

In one embodiment, there is a relationship between the size of the magnetic cavity 202 and the width 406 of the receiver coil element 400. The impedance of the receiver element 201 should be small enough to permit high inductance resulting in a low corner frequency around 1 Hz and below.

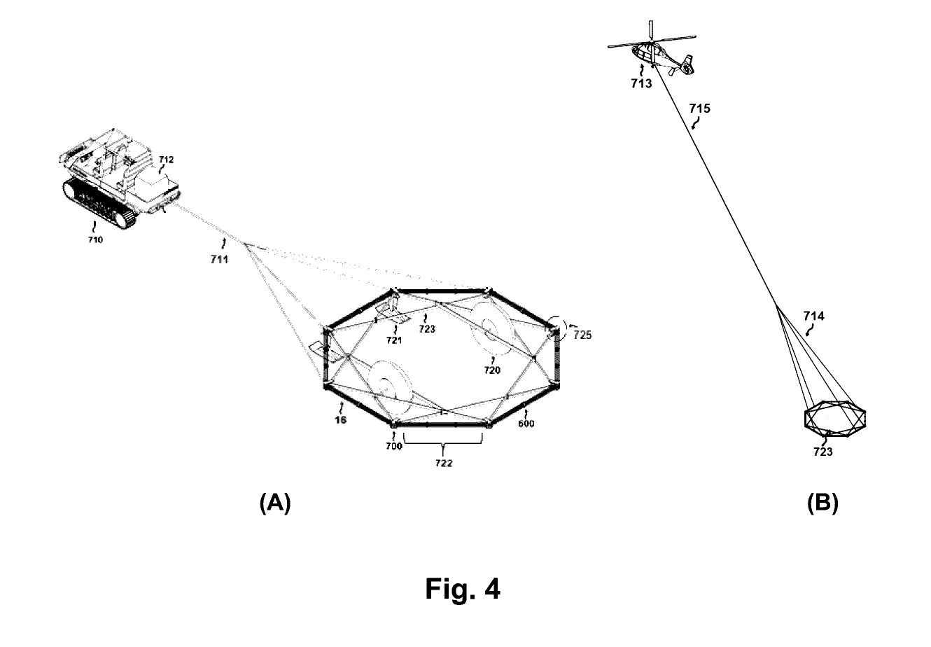

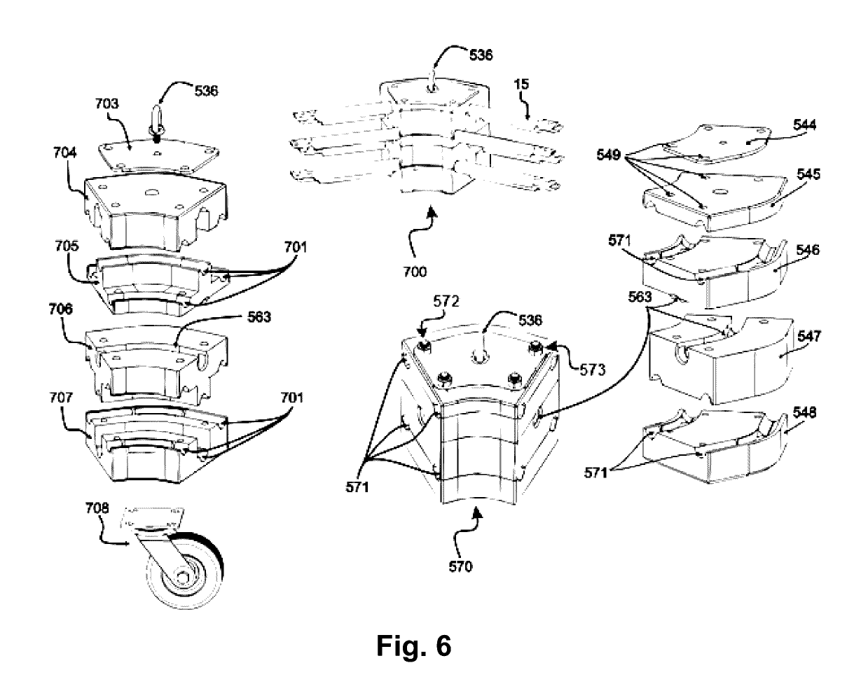

FIG. 4 shows a true concentric and coincident Tx-Rx loop configuration with inner support structure where at least one receiver element is embedded within the arrangement of transmitter elements. That is, a true concentric and coincident loop configuration is such that at least one receiver element is placed at the center of transmitter elements arrangement. For this coincident loop configuration, the center is not the center of the Tx-loop (as defined by the central loop) but determined by (OD−ID)/2, where OD and ID correspond to the outer and inner diameters of the Tx-loop, respectively. In the coincident loop configurations, the receiver element and the transmitter elements are about the same size and the radius of the receiver element must be equal to (OD−ID)/2 within a tenth of millimeter in accuracy. The positioning of the receiver elements within the transmitter elements requires a machining of parts with a tolerance of at least 0.1 mm and this precise positioning is achieved by inserting the receiver element at the center 560, 653 of straight blocks 500 or spacers 600 (also see FIGS. 5 and 6), respectively. Advantageously no bucking coil is required if an even number transmitter elements are placed symmetrically and equidistantly from the receiver element and therefore a magnetic cavity 202 is created at the center of the transmitter elements arrangement using the primary field generated by the arrangement of parallel and equidistant transmitter elements. An inner supporting structures allows to use the system for mobile ground EM surveys (A) or airborne (B). The use of straight blocks 500, 601 (spacers 600) and corner blocks 570, 700 (still also referring to FIGS. 5 and 6) maintain a fixed distance between the transmitter and receiver with a compact and light coincident Tx-Rx design. The aerodynamic design of the straight blocks and/or spacers as well as the corner blocks reduce weights and minimize air drags to conduct airborne time-domain EM surveys at 100 km/h.

In another embodiment, a true coincident Tx-Rx loop is one comprising at least one receiver coil in the same plane as the Tx and of about the same size. Such a coincident Tx-Rx plane for central loop configurations is achieved with a rigid structure or using a semi-rigid structure with the aid of suspension mechanisms. For a true coincident Tx-Rx loop, the alignment is guaranteed by light weight spacers (e.g. straight block arrangement) and corner blocks (e.g. corner block arrangement) that maintain a fixed separation between the receiver and transmitter elements. The receiver coil is placed at the center (560, 563, 653) of the transmitter elements arrangement of an even number of turns as for the transmitter coil elements, such that the primary field generated from the turns of the transmitter coil elements is responsible to create the magnetic cavity shown on image 200 where the receiver coil element 80, 400 (see FIGS. 7 and 8) is placed. This can be effectively accomplished by using an even number of turns for transmitter coil elements and by placing them in parallel one with respect to the other and equidistant from the center where the receiver coil element 80, 400 is placed. If the current is set to circulate in the same direction for all turns of the transmitter coil elements, then the lines of force of the primary induction field will cancel out at the center of the turn arrangement resulting in null primary magnetic field intensity at the center of the arrangement of turns of transmitter coil elements.

The simplicity of the mechanical design allows a fast field assembly. Typically, the assembly takes less than four hours and, once completed, the system can be towed by a ground vehicle 710 or a helicopter 713. The data acquisition system 140 and switching system 60 (see FIG. 8) embedded in 712 and can be mounted on the ground vehicle or hooked from the top to the main line of the helicopter and from the bottom to four ropes 714 attached to hooks 536 of corner blocks 700. It is advantageous to use only four ropes 714 to lift the system up for airborne applications. As the airborne system speeds up the ropes impart vibration to the system and therefore deteriorate the SNR. In case the system is used for ground survey a towing mechanism 711, 715 that consists in a straight bar directly connected to the hook 536 of a corner block. Two ropes from the closest two hooks are attached to the midsection to the bar helps to evenly distribute the pulling force applied to the main towing corner block as well as maintaining the Tx-Rx arrangement in a stable position while towing.

According to an embodiment, non-conductive block elements comprise either one of a straight block arrangement (i.e., straight blocks 500, 601 or spacers 600 of FIG. 5) or a corner block arrangement (i.e., corner blocks 570, 700 of FIG. 6). The straight block arrangements are configured for straight portions 722 [to be added to figures, I am not referring to the spacers, but to the straight portions held in place by the spacers] of the loops segments and the corner block arrangements are configured for corner portions 725 [to be added to figures, not referring to corners blocks, but to the corner portions held in place by the corner blocks] of the loops segments.

In an embodiment, the fabrication of straight blocks 500, 601 and spacers 600 of FIG. 5 and corner blocks 570, 700 of FIG. 6 are such that the position of grooves 571, 602, 701 where transmitter elements are inserted run parallel and equidistant from the center 653, 560 (for spacers) and 563 (for corner blocks) and along the circumference defined in the plane “xy” 203 (of FIG. 3). The total number of grooves is an even number of turns and they need to be inserted symmetrically and at about the same distance from the center 202 of the transmitter turn arrangement.

In one embodiment, the receiver coil element 400 is embedded within an even number of turns of transmitter coil elements and connected to the ground 81, 405 (see FIGS. 7 and 8) to nullify the coupling and thereby the mutual inductance among transmitter coil elements. This results in a transmitter with very low inductance as the mutual inductance between the transmitter elements cancel out and the only contribution to the inductance of the transmitter is given by the self-inductance of each turn allowing a fast switching off the primary pulse of current.

In another embodiment, four grooves formed into straight blocks 500 and corner blocks 570 is a good tradeoff for having a light weight and low inductance transmitter system suitable for either ground or airborne electromagnetic soundings.

In another embodiment, six or more grooves 602 performed into the straight blocks 601 and grooves 701 in corner blocks 700 is a good tradeoff for having light weight and low inductance transmitter system suitable for ground and deep airborne electromagnetic soundings for a transmitter/receiver loop of 8 meters in diameter.

FIG. 5 shows straight blocks 500, 601 and spacers 600 with their sections corresponding to its assembly. The fabrication of straight blocks and spacers are made for easy packing for transportation as well as to assemble and disassemble them during field operations. These blocks are intended to maintain a fix distance between the transmitter elements and the receivers while surveying. The straight block 501 is bulky and suitable for conducting electromagnetic surveys towed by ground vehicles 710 (see FIG. 4) where the weight of the system is not relevant. Using the straight block 501 it is possible to clamp up to four transmitter elements, by means of grooves 534 (and bolts 544, nuts 545) and build a Tx loop having four turns. This block 501 is intended for larger transmitter loop (e.g.; loop OD greater than 8 m) while the straight block 601 is about 1″ thick serving to clamp, using grooves 602 and two bolts 650, up to six turns. This is the lighter version of block 501 suitable for conducting airborne surveys to assemble a medium size transmitter of about 8 m on diameter. Sections of grooves 602 indicated by 645, 646, 647, 648 are mechanically different from those of straight block 501, yet have the same functionality to clamp, using grooves 602 and nuts 650 the straight transmitter elements 16. The lightest version of these straight blocks 501 and 601 is the spacer 600. The inner sections 654, 655, 656, 657 of spacer 600 are mechanically identical to those of grooves 602. The difference resides in the exterior aerodynamic design and further weight cuts of perforations 608. These blocks can be used to form the Tx loop depending on the specification of the survey. For instance, a magnetic dipolar moment (N×A×I) of about 151,000 A/m² can be generated having 6 turns, 8 meter loop and a current pulse of 500 A, which is suitable for an airborne EM survey.

In one aspect, the bottom section of the straight block 501 serves to clamp up to four transmitter elements. Its bottom part 543 connects from the upper side with a lower middle section block 542 and the lower side with balloon wheels 708 (an example of surface interfaces) (see FIG. 7) that are secured together (bolted, according to an embodiment) from the lower part of 543. These balloon wheels 708 in straight block 501 may help to minimize overall vibration of the system during the ground survey. To minimize air drag, these balloon wheels 708 can be removed to conduct fasters airborne EM surveys. In addition, these balloon wheels 708 facilitate the displacement of the system while towed by a ground vehicle 710. The straight block 501 has four grooves 534 to clamp the straight transmitter elements 16 (aka conductive bar elements) (see FIGS. 4 and 7).

According to an embodiment, an alternative nature for the surface interfaces is used instead of balloon wheels 708. According to an embodiment, the surface interfaces are skis 721. According to another embodiment, the surface interfaces are floats. Regardless the nature of the surface interfaces, they are attached to the bottom section of the corner blocks or the inner frame structure 723 with wheels 720 and skis 721 added to the Tx-Rx arrangement for a more compact and rigid design required for towed EM ground surveys. The type of attachment is selected based on the on the type of electromagnetic prospection to be performed.

In another aspect, the middle section block 542 of the block 501 connects from its upper part with middle upper section block 541. The groove 534 is at the center of the straight block 501 and is used to insert a non-conductive PVC tube 709 (see FIG. 7) containing the flexible Rx receiver coil element 400. The interior of the PVC tube 450 (see FIG. 7) is covered with anti-vibration composite damping sheets 760 to absorb vibrations imparted to the tube by the wind. The upper section block 541 contains two grooves to insert straight transmitter elements 16 forming the Tx. The uppermost section block 540 connects from its upper part with a towing plate 537 having a hook 536 and a set of bolts 544 and nuts 545. This towing plate 537 serves to tighten and to secure all the section blocks 540, 541, 542, 543 with the help of non-metallic bolts 544. The hook 536 serves for both ground and airborne towing.

In one embodiment, if the apparatus is towed by a ground vehicle 710 with ropes 714 hooked to towing plate 537. These hooks 536 are shown on in the straight blocks 500, 601 and corner blocks 570 and 700. Wheels 720 and front ski pad 721 are used for smooth ground towing.

In another embodiment, if the apparatus is towed by an airborne vehicle, only corner blocks are attached to the main long line 715 of the helicopter 713. Ropes 714 attached to middle sections of the straight portions 722 of the loop segments.

FIG. 6 shows the corner blocks 570 and 700 have the same functionality as straight blocks to maintain a fixed distance between the transmitter elements and the receivers while surveying. Likewise, the fabrication of the straight blocks is such that they are easy to pack for transportation and to assemble and to disassemble during field operations. The bottom section 707 connects from its upper part with the middle low section 706. The lower part of the bottom section 707 connects from its lower part with balloon wheel 708.

In one aspect, the angle sustained by the grooves 563 is related to whether the Tx geometry is of decagonal, octagonal, or hexagonal shape. The octagonal Tx geometry is the best compromise between the sharp angle created by the hexagonal and smother angle of the decagonal. A decagonal geometry is not practical as the apparatus becomes heavier as more straight and corner blocks are used. The octagonal configuration is a good electrical and mechanical compromise to avoid heat losses due to the sharp turning of the current at these edges.

In one aspect, the lower middle section 706 is clamped to the upper middle section 705 forming a tubular aperture 563 for the insertion of the flexible Rx receiver coil element 400. The upper section 704 is also clamped to the upper middle section 705 and the corner towing plate 703. Once all parts 703, 704, 705, 706, 707, 708 are clamped with non-metallic bolts 572 and nuts 573, they form the corner block 700 or 570. Mechanical design of corner blocks 570 and its parts 545, 546, 547, 548 is different from 700 as it is intended to clamp four angular transmitter elements 15 by grooves 571 (see FIGS. 6 and 7). Yet, they have the same towing plate 544 and towing hook 536. In addition, the groove 563 is formed for both corner blocks once the adjacent parts 705 and 706 (700) or 545 and 546 (570) are bolted together throughout the holes 549.

In another aspect, either straight or corner blocks are built from ultra high molecular weight polyethylene (UHMW-PE) being extremely tough and durable with low friction, excellent abrasion resistance, good chemical resistance and low water absorption. This material is used to build the four sections forming the block element. This material guarantees long durability and minimal wear and tear over time.

In one aspect, straight and corner blocks are used to insert straight transmitter elements 16 and corner transmitter elements 15 (see FIG. 7), respectively. The straight transmitter elements 16 are inserted into the grooves 534 for the straight blocks and spacer 602 while corner transmitter elements are inserted throughout the grooves 571 and 701 for the four corner block 570 and 700, respectively. The flexible receiver coil element 400 is clamped to the corresponding upper, middle and bottom block sections to form the true Tx-Rx coincident loop configuration.

In another aspect, straight (spacer) and corner blocks are used to insert the flexible Rx receiver coil element 400 into the grooves 560, 653 and 563, respectively. A tubular cavity throughout the blocks is formed once corresponding middle block and spacer sections are clamped together. These blocks and spacer hold symmetrically the receiver coil element 400 with respect to either straight (corner) transmitter elements 15 (16), respectively.

FIG. 7 shows the large flexible air core inductor magnetometer receiver coil element 400 with an outer diameter 403 of at least 8 m and width 406. The air core electromagnetic receiver coil element 400 was referred in the introductory paragraph as the Rx.

In one embodiment, the receiver coil element 400 is a custom made air core receiver and its fabrication is an engineering challenge. This is mainly because in conventional windings, 1 m is possible with special adjustments, but winding of 8 meter coils is not possible. This industrial winding is of importance because the receiver coil element must have high mutual inductance to be able to pick up smallest variations of secondary magnetic flux down to 1 nT/s at depths of hundreds of meters. This high mutual inductance is achieved with few a hundred turns only and only if the tension applied during winding is the maximum to keep the wire arrangement in receiver coil element 400 tight enough and with a hexagonal packing. This type of packing is preferable as the mutual inductance air core induction magnetometers increases while keeping relative small impedance values for an air coil induction at low frequencies (see for instance “On Evaluation of Inductance, DC Resistance, and Capacitance of Coaxial Inductors at Low Frequencies” IEEE Trans. on Magnetics, Vol. 50, Issue 7, 8401012, by Martinez et al. 2014). The receiver coil element 400 is made of one thin wire 401 of about 30 AWG. The wire gauge depends if the wire used is a solid wire or Litz wire and whether the material is copper or aluminum. To further minimize the electromagnetic interference and to avoid parasite currents induced due to geological noises of remnants induction currents from the primary field Hp the receiver coil element 400, 80 is shielded with shielding elements, namely one or several layers of aluminum 402 and grounded 405. The thickness of the layers of aluminum 402 is calculated based on the system base frequency f_{b} as dictated by the skin depth, i.e. sqrt(1/πf_{b}μσ).

In another embodiment, the receiver coil element 400 is built using the corner blocks 570, 700 and straight blocks 501, 601 and spacer 600. A precise method of winding to give the tension and compactness is required to have the necessary compact and flexible receiver coil. Advantageously, once the receiver coil element 400 is built has the form of a common cable that can be used for long periods since the added water proof layers increase the durability of the flexible receiver cable. Once the system is assembled is at the center of the transmitter elements as depicted FIG. 7. In order to have multiple turns for the Tx, the straight transmitter elements 16 must be combined with the corner transmitter elements 15 with a series of transition elements 751, 752, 753, 754, 755 as depicted in the area 750. The orientations of these transition elements with respect to one another are of importance to maintain the magnetic cavity shown on image 200 in that region as well. The voltage/current driven by the switching system 60 (see FIG. 8) is applied to the Tx using high voltage cables [not shown] fasten by bolts 757 into the Tx connectors 756.

In another embodiment, the transversal cross section of the flexible receiver coil element 400 once inserted into the PVC tube 709 is depicted by arrow 450. Damping viscoelastic foam 780 minimizes the vibrations of the receiver coil inside the PVC tube and thus reduction the phonic noises. The total number of turns for thin wire 401 of the coil element 400 is optimized for certain bandwidth and set of impedances according to survey characteristics. Several flexible coil receivers can be built and specifically designed for high conductive, medium conductive or poor conductive terrains in advance. Easy replacement of the receiver cable is guaranteed by insertion into grooves 563, 653 during the assembly of the system.

In another embodiment, the width 406 of the receiver coil element 80, 400 is optimized for having low impedance and for specific bandwidths. The low corner frequency of the Rx is determined as:

$${f}_{L} = \frac{{R}_{DC}}{2 π L} ,$$

where R_{DC} is the dc resistance of the receiver and the symbol L=Lₒ+M accounts for the self Lₒ- and mutual M-inductances. The mutual inductance accounts for the electromagnetic coupling of each wire with respect to other wires of the arrangement. The sensitivity of the receiver is high as more thin wires are tightened into the receiver coil element 400; this increases M and therefore L thereby lowering the low corner frequency f_{L}. The high frequency corner on the other hand is

$${f}_{H} = \frac{1}{2 π \sqrt{LC}} .$$

A detailed description of the physics behind the design of high resolution air core induction magnetometer can be found in Martinez et al. 2014, “On Evaluation of Inductance, DC Resistance, and Capacitance of Coaxial Inductors at Low Frequencies” IEEE Trans. on Magnetics, Vol. 50, Issue 7, 8401012. Once the bandwidth Δf=f_{H}−f_{L} and the diameter 403 of Rx are specified it is possible to optimize the coil width 406.

In another aspect and referring to FIG. 8, the alternate current circulating in the receiver coil element 80, 400 is I=A₀[H_{z}(t_{b})]ᵢ/Z, where A₀=2πμ₀ωA_{eff} in [mΩs] and Z=\sqrt{R_{dc}²+X_{L}²} with X_{L}=ωL if the secondary magnetic field intensity exhibit a harmonic time dependence. This means that at low frequencies ω the output current at the receiver clips 82 is limited by the R_{DC}. Conversely, X_{L} is predominant term when ω increases. This fact has a profound implication on the fabrication of the receiver coil element 80, 400 since if one wants a flat frequency response from the loop, one way to get it is by short circuiting the output and use the output current instead of voltage.

In another embodiment, the noise voltage eₙ (equivalent noise voltage density of the op-amp, usually expressed in nV/Hz^{1/2}) causes a noise current iₙ to flow in receiver coil element 80, 400. The noise current iₙ is determined by

$${i}_{n} = \frac{{e}_{n}}{Z}$$

(noise floor of the antenna system, expressed in nA/Hz^{1/2}) which results in a harmonic dependence of the electromagnetic fields. An equivalent magnetic field noise seen by the circuit

$${e}_{H} = \frac{{i}_{n}}{2 π {fA}_{eff}} Z ,$$

leads to the noise floor equation for the circuit

$${e}_{H} = \frac{{e}_{n}}{2 π {fA}_{eff}} ,$$

which in pT yields:

$${e}_{B} ( pT ) = \frac{{10}^{3} {e}_{n}}{2 π {fA}_{eff}} .$$

The former is the central expression for designing a highly sensitive induction air core magnetometer with very low noise floor for the receiver coil element 80, 400.

In one embodiment a large receiver effective area: A_{eff}=k·Nᵣₓ·dᵣₓ²; where k=0.8284 for an octagon with dᵣₓ, Nᵣₓ the effective receiver diameter and the number of turns, respectively) lowers the noise presented in the receiver coil element 80, 400.

FIG. 8 refers to another embodiment of an electromagnetic prospecting system 100. According to equation (3) the SNR improves by square root of the sampling rate, S_{R}. The sampling rate, S_{R}, determines the ability to gather more samples per half cycle and that is useful to increase the SNR by capturing more samples of those secondary signals vanishing within few milliseconds. In addition, the S_{R} determines the overall system's performance because the control of transmissions (pulse of current) and recordings (induced voltages) needs to be controlled by the data acquisition system within the shortest time stamp possible. This is a challenging task because the algorithms for the close current control for the generation of the primary field have to be optimized as well. For instance, if f_{b}=30 Hz and one clock cycle of the data acquisition system (DAS) is rated at 40 MHz, i.e., one tick=25 ns having an analog module with a sampling rate of S_{R}=500 kS/s, this will result in a sampling interval of 2 ρs (i.e., system tick is: 40 MHz/500 k=80 ticks and thus 80×0.025μ=2 μs). Handling such a high volume of samples within a half period becomes impossible if microprocessor logic and chopping algorithms are not designed and optimized. The total number of samples available for stacking purposes (see equation (8)) for one transient is: Ns=SR/2f_{b}=8,333 samples.

In another embodiment, the data acquisition system 140 controls the transmission and reception by means of high intensity magnetic field through the switching excitation system 60 and the reception of the secondary slow varying magnetic field intensities using the receiver coil element 80, 400 as receiver elements.

In one embodiment, the protocol of communication 144 between the computer storing device 148 and the controller 147 is via TPC/IP or a wireless connection.

In one embodiment, the data acquired by the analog-to-digital converter 90 is transferred from I/O modules 145 to the computer storing device 148 using Direct Memory Access (DMA) 142. An advantage of transferring data using DMA 142 is multiplexed continuous data logging without losing any data. Inside the critical acquisition and logging loop, the data can be written to the circular buffer using DMA 142. This is a special function architecture defined for deterministic data transfer between Field programmable gate array (FPGA) 146 and computer storage device 148. It consists of two parts. The first part of this FIFO DMA 142 is on the FPGA 146. It uses block RAM on the FPGA device and is used to read the data from I/O modules 145. The second part of the DMA FIFO is on the controller 147. This portion of the FIFO uses memory on the controller 147. A DMA engine automatically transfers data from the FPGA device RAM to the host machine memory.

According to another embodiment, the transmission of the pulse of current is controlled by a control loop residing on FPGA 146. The execution time of the control loop and data acquisition loop is very sensitive to the coding practices. One function such as reading/writing the input/output from I/O module 145 can be achieved in many different ways of coding. Using machine state programming allows control the switching system 60 by the control loop with a time stamp of at least two microseconds while another acquisition loop controls I/O modules 145 within the same time stamp of two microseconds.

According to the described embodiments, data acquisition system 140 is an autonomous and closed loop synchronized network within nanoseconds using synchronizer 141 and triggered by GPS trigger 50. Once the pulse per second of GPS trigger 50 is received by I/O modules 145, an interruption residing on FPGA 146 triggers the control loop for transmission of the pulse of current via buses 143. The switching excitation system 60 delivers the pulse of current through the connections 756 (see FIG. 7) into the straight (corner) transmitter elements represented by 70. The switching excitation system 60 programmatically modulates the pulse of current to take the form of a square-, sinusoidal-, or triangular-pulse. During the time the pulse of current is on the transmitter element 70 a small current in switching excitation system 60 is induced. The current to voltage converter 185 is the preamplifier and converts the current into voltage according the designed pre-amplification stages.

In one embodiment, the S_{R}=500 kS/s doubles the acquisition speed of the fastest airborne electromagnetic system of Colorado mine: NEWTEMII (e.g. P. A. Eaton, R. G. Anderson, S. V. Queen, B. Y. Nilsson, E. Lauritsen, C. T. Barnett, M. Olm, and S. Mitchell, 2013 Helicopter time-domain electromagnetics—Newmont and the NEWTEM experience, Geophysics, November 2013, v. 78, p. W45-W56) further increasing the system SNR.

### Exemplary Embodiments

An airborne electromagnetic survey consists in a series of lines flown by an aerial vehicle, such a helicopter, inside a block area. The block area is composed by traverse lines spaced by about 200 meters and control lines (perpendicular to the traverse) spaced about 1 km. The helicopter needs to be equipped with an online correction for a global positioning (GPS) to accurately determine the spatial coordinates of the block during the survey. The raw voltage recorded by the receiver coil element 80, 400 is averaged by FPGA 146 once the signal has been de-spiked from atmospheric noises and dc shifts and signal trends have been removed. These operations are embedded into the FPGA 146 to guarantee fast signal processing and data acquisition. The voltage that is triggered by GPS trigger 50 at time t=tb is:

$${\{ {V}_{{R}_{z}} ( {t}_{b} ) \}}_{i} = 2 π {μ}_{0} {A}_{eff} \frac{{\sum }_{j = 1}^{{m}_{T}} {\{ {H}_{z}^{′} ( {t}_{b} ) \}}_{i , j}}{{m}_{T}} \qquad ( 10 )$$

where μ₀ is the magnetic permeability of free space (μ₀=4π·10⁻⁷ H/m) and H′_{z} [A/m] denotes the first derivative of the secondary magnetic crossing the receiver effective area: A_{eff} [m²].

The design of receiver coils in the prior art are small in size where dᵣₓ˜1.1 m. The flexible receiver coil element 80, 400 where dᵣₓ˜8 m results in at least a two order of magnitude improvement on A_{eff} and thereby the voltage at the receiver clips 82 according to equation (10). That is, since A_{eff} depends on the squared receiver's radius, a receiver in the order of cm will have an A_{eff} two orders of magnitude less than those in order meters. Once the impedance of the coil has been optimized, and due to the fact dᵣₓ˜8 m, this may result in at least three orders of magnitude of improvement for the system's SNR.

In one example of the embodiment, Equation (10) is a row vector and the bracket { }ᵢ indicates one measurement or realization. The inner summation on the right-hand-side of the equation runs from the first transient j=1 to the total number of transients m_{T} available for stacking. The total transients available depends on the system base frequency fb and survey sampling frequency, fₛₐₘₚ. That is: m_{T}=2f_{b}/fₛₐₘₚ, where fₛₐₘₚ depends inversely on the speed of helicopter, vₕ, i.e., fₛₐₘₚ=vₕ/d. Therefore, m_{T}=2f_{b}d/vₕ. Clearly, the way the survey is conducted influences the system's SNR; for instance firing the system at higher f_{b} and spreading the acquisition to larger “d” one obtains an improvement of the SNR, but at the expense of shallow penetration and poor lateral resolution, d. In any case, increasing vₕ reduces m_{T}. For a survey conducted with: f_{b}=30 Hz, vₕ=60 m/s and d=4 m, results in only four transient are available for stacking. That means that at higher helicopter speeds, the strength of the signal must be high enough to be able to resolve the signal with only m_{T}=4. Once the signal is stacked, this results in a vector row:

[V_{z}(t_{b})]ᵢ=2πμ₀A_{eff}[H′_{z}(t_{b})]ᵢ. (11)

Ultimately, the open voltage of equation (11), not at the terminal output of the receiver, but at the input of the data acquisition system 40, depends on the encoding of the analog-to-digital converter 90. The voltage resolution, Res (minimum voltage that can be converted from analog to digital) depends on ADC bit resolution. An ADC rated at 5V and 16 bits encoding will give: Res=5V/216=73.3 μV. In other words, below 73.3 μV, the DAS is not able to “see” the signal regardless the optimization imparted to receiver coil element 80, 400 described earlier or preamp stages performed in the current to voltage converter 185. Therefore, it is desired that the system has fast ADC encoding (e.g. 32, 128, etc.) to help to improve SNR and overall signal amplification stages.

In another example, the computer storage device 148 does this last re-sampling, which is typically referred as gating or windowing. The signal is stacked by tacking a set of samples and giving the mean time. Gates are designed such that few samples are taken in early time at the beginning and then increasing monotonically as the time goes by deep into later times (t>>tau). The open voltage yields: [V_{z}(t_{b})]_{1×Ng}=Aₒ×[H_{z}(t_{b})]_{1×Ng}. To normalize measurements with respect to the highest voltage induced by primary field results: Aₒ(ppm)=VₒG/V₁×10⁶ in [nT/s/V]; where V₁ is half peak to pick the receiver voltage due to the primary field in Volts [V]. And G is the amplification gain of the system. Typically V₁ is given in ADC units and it can be converted to voltage by multiplying by Res defined above. For instance, if V₁=2×10⁴ ADC, the equivalent in volt is 2×10⁴ ADC×73.30 μV/ADC=1.5V. Note that the symbol Ng denotes the total number of time gates. A system time gate file having at least three columns (e.g., sample number, the start and end time respectively) is created.

The decay times are measured by data acquisition system 140 from 2 microseconds after switching off the current into the transmitter and until 15 milliseconds. The computer storage device 148 calculates the time decay constant typically referred as τ “tau” for discrete conductors

$$A ( {t}_{j} ) = {A}_{o} {e}^{- \frac{1}{τ} {t}_{j}} ,$$

where tⱼ is the window center time in “ms” of the j-th time gate. The physics meaning of τ is to be a time mark of the voltage that receivers can withhold before being confused with geological and instrumentation noises. In this case, tau coincides with the time at which the open voltage at the receiver signal decays 37% from its initial value. This value is named A₃₇. Instead of linearizing the above expression or applying a nonlinear fit, a code in the computer storage device 48 seeks in the dataset A₃₇-value. Then, the tau is calculated from the system time gate file loaded into the memory of computer storage device 148 and finally computes the tau by a weighted interpolation. That is: τ=ωⱼ·tⱼ+ωⱼ₋₁·tⱼ₋₁, where ωⱼ and ωⱼ₋₁ are the weights applied to the j-th and (j−1)-th centre time gates, respectively. The weights are calculated as:

$${ω}_{j - 1} = ( 1 - \frac{{A}_{37} - {A}_{j - 1}}{{A}_{j - 1} - {A}_{j}} ) and {ω}_{j} = ( 1 - \frac{{A}_{j} - {A}_{37}}{{A}_{j - 1} - {A}_{j}} ) .$$

Other methods of interpolation of the time gates using the amplitudes of the signal before Aⱼ₋₁ and after Aⱼ the 37% A₃₇ can be also implemented. Therefore, this calculation is not restricted to this way of calculation; other methods may be conceived.

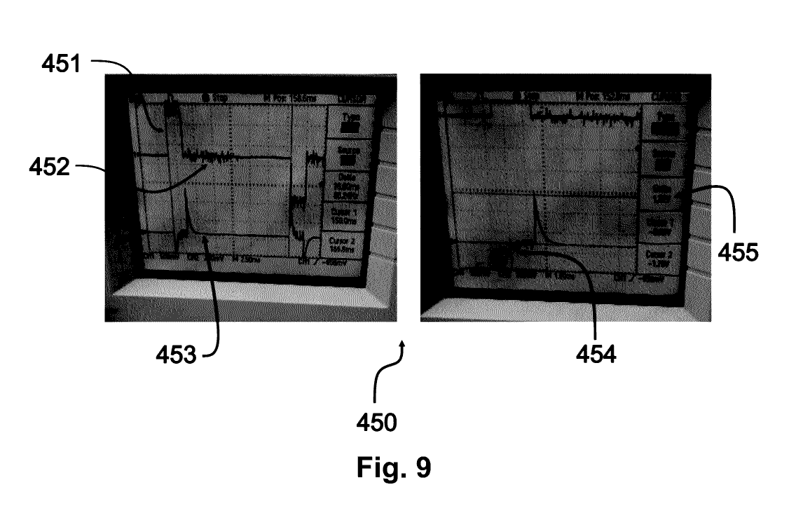

The embodiment shown in of FIG. 9 is a snapshot of two transients recorded by an oscilloscope for a square biphasic current 451 when the system is fired at 500V/100 A and base frequency, fb=30 Hz (16.6 ms for half cycle) for a ground field test. The low inductance of the transmitter coil elements (N_{TX}=4 turns and OD_{TX}=5 m) allows fast switching off in about 40 μs creating an almost perfect square pulse for the system. Several switching systems 60 for high power systems are known in the art. Regardless of the topology implemented, they are noisy due to the multiple switching embedded therein. The high frequency noise appearing at the transmitter coil 452 are not present at the receiver clips 453. This is due to the flexible receiver coil that is almost not sensible to primary field excitation of the transmitter coil as it results in almost null voltage 454 and the receiver clips 82. This ground test was done without amplification and current to voltage converter 185 was replaced by a 40Ω resistor. The signal strength was measured between the cursor on the oscilloscope and yielded a 1.22V peak to peak voltage 455. That means that due to large effective receiver area and optimization of the flexible receiver coil element 80, 400, the voltage at receiver clips 82 is at least six orders of magnitude higher than in known prior art methods (typically recorded within microvolts). This implies that pre-amplification stages may not be needed for conducting deep electromagnetic soundings towed by ground vehicles using such large receivers with OD˜8 m.

In an embodiment for airborne electromagnetic surveying, a slight decrease of the SNR is expected due to the terrain clearance (˜30 m above the ground).

1. A system for electromagnetic prospecting comprising:
transmitter coil elements configured to create a magnetic cavity upon transmission of primary magnetic fields from the transmitter coil elements; and
a receiver coil element configured to detect secondary magnetic fields, wherein the receiver coil element is positioned substantially at the center of the transmitter coil elements where the magnetic cavity is created.

2. The system of claim 1, wherein the transmitter coil elements each comprise an even number of conductive bar elements which are radially and equidistantly distributed about the receiver coil element.

3. The apparatus of claim 2, wherein the conductive bar elements form a path formed by loop segments.

4. The system of claim 3, further comprising non-conductive block elements wherein the loop segments are fixed to the non-conductive block elements and wherein each one of the conductive bar elements is positioned equidistant from the center of the non-conductive block elements.

5. The system of claim 4, wherein the non-conductive block elements comprise either one of a straight block arrangement or a corner block arrangement and the loop segments comprise straight portions and corner portions, wherein the straight block arrangement is configured for maintaining the conductive bar elements equidistant in the straight portions and the corner block arrangement is configured for maintaining the conductive bar elements equidistant in the corner portions.

6. The system of claim 5, wherein the non-conductive block elements have an upper section, a middle section, and a bottom section secured together, wherein the upper section comprises a hook for connecting to a towing cable and the middle section comprises a groove for receiving the receiver coil element.

7. The system of claim 6, further comprising at least one of a set of balloon wheels, skis or floats attached to the bottom section of the corner block arrangement.

8. The system of claim 4, wherein the non-conductive block elements are made from ultra high molecular weight polyethylene.

9. The system of claim 1, further comprising an inner frame structure and at least one of a set of balloon wheels, skis or floats attached to the inner frame structure.

10. The system of claim 1, wherein the receiver coil element comprises a flexible air core inductor magnetometer receiver coil element and a shielding element surrounding the flexible air core inductor magnetometer receiver coil element.

11. The system of claim 10, wherein the flexible air core inductor magnetometer receiver coil element comprises an induction coil made of solid wires or Litz wires.

12. The system of claim 10, wherein the shielding element comprises thin sheets of conductive material.

13. The system of claim 10, further comprising non-conductive block elements, wherein the transmitter coil elements each comprise an even number of conductive bar elements which are radially and equidistantly distributed about the receiver coil element, wherein the conductive bar elements form a path formed by loop segments, wherein the loop segments are fixed to the non-conductive block elements, wherein each one of the conductive bar elements is positioned equidistant from the center of the non-conductive block elements, and wherein the flexible air core inductor magnetometer receiver coil element comprises a cable held at the center of the non-conductive block elements and concentric to loop segments.

14. The system of claim 10, further comprising damping viscoelastic foam and an non-conductive tube, wherein the flexible air core inductor magnetometer receiver coil element is wrapped with damping viscoelastic foam and encapsulated inside an non-conductive tube.

15. The system of claim 10, wherein the flexible air core inductor magnetometer receiver coil element operates defines an antenna which is optimized for one of an impedance, a bandwidth and a noise floor.

16. The system of claim 1, further comprising a data acquisition system configured for transmitting the primary magnetic fields from the transmitter coil elements and for recording voltages induced by secondary magnetic fields from ground formations in a target area.

17. The system of claim 16, wherein the data acquisition system is further configured for interpreting a signal based on a calculation of magnetic sensitivity kernels that produce measurements at the receiver coil element due to secondary electric fields Jₛ(r,ω) raised in any part of the target area by the secondary magnetic fields.

18. The system of claim 16, wherein the data acquisition system is connected to the receiver coil element and to the transmitter coil elements, wherein the data acquisition system is triggered by a clocked pulse from an external GPS signal.

19. The system of claim 16, wherein the data acquisition system comprises a machine readable storage medium having stored thereon a computer program having code sections, the code sections executable by the data acquisition system to perform at least one of the steps of:
triggering at least one pulse sequence controlled by a microprocessor with at least one microsecond of precision;
controlling a current pulse sequence, wherein the current pulse is a monophasic or biphasic square pulse of current of at least 300 A and lasting at least 2 milliseconds; and
acquiring and transmitting data at a speed of least 500,000 samples per second for recording both primary and secondary fields detected by the receiver coil element.

20. The system of claim 19, wherein the code sections further cause the data acquisition system to perform a computation of magnetic sensitivity kernels which is calculated by a vector boundary element method that comprises the steps of:
specifying positions r_{g} and rᵥ in a lattice of a generating volume R_{g} and of a volume conductor Rᵥ;
specifying a conductivity profile using an approximation such that each set of layers constitutes a collection of N embedded regions for which a conductivity value is constant, σ={σ₁, . . . , σ_{N}};
calculating numerically values for electric field E_{kV}(ω)=Eₖ(ω,rᵥ) on each rᵥ of the lattice of the volume conductor Rᵥ that belongs to surfaces limiting the embedded regions by means of linear algebraic systems of equations as:
DE(ω)=E_{N∞}(ω)−ME(ω)
wherein E_{N∞}(ω)=(E_{1∞}, E_{2∞}, . . . , E_{N∞})^{t} and E(ω)=(E₁, E₂, . . . , E_{k,k+1})^{t}; N_{k,k+1} is a number point rᵥ that belongs to a specific one of the surfaces separating the embedded regions k and k+1, wherein matrices M and D are being defined as:
$$M = \frac{1}{4 π} [ \begin{matrix}\frac{( {σ}_{2} - {σ}_{1} )}{{σ}_{2}} {H}_{11} & \frac{( {σ}_{3} - {σ}_{2} )}{{σ}_{3}} {H}_{12} & ⋯ & \frac{( {σ}_{N} - {σ}_{N - 1} )}{{σ}_{N}} {H}_{1 N - 1} & {Γ}_{1 N} \\ \frac{( {σ}_{2} - {σ}_{1} )}{{σ}_{2}} {H}_{12} & \frac{( {σ}_{3} - {σ}_{2} )}{{σ}_{3}} {H}_{22} & ⋯ & \frac{( {σ}_{N} - {σ}_{N - 1} )}{{σ}_{N}} {H}_{2 N - 1} & {Γ}_{2 N} \\ ⋮ & ⋮ & ⋮ & ⋮ & ⋮ \\ \frac{( {σ}_{2} - {σ}_{1} )}{{σ}_{2}} {H}_{1 N} & \frac{( {σ}_{3} - {σ}_{2} )}{{σ}_{3}} {H}_{2 N} & & \frac{( {σ}_{N} - {σ}_{N - 1} )}{{σ}_{N}} {H}_{NN - 1} & {Γ}_{NN}\end{matrix} ]$$
$$D = [ \begin{matrix}{α}_{1} {I}_{{N}_{1 , 2}} & & 0 \\ 0 & & 0 \\ 0 & ⋱ & 0 \\ ⋮ & & 0 \\ 0 & & {α}_{N} {I}_{{N}_{N , N}}\end{matrix} ] where \text{:} {α}_{j} = \{ \begin{matrix}\frac{( 2 {σ}_{j + 1} + {σ}_{j} )}{3 {σ}_{j + 1}} & j \neq N \\ \frac{7}{6} & j = N\end{matrix} and \\ {Γ}_{jk} = ( \begin{matrix}{Γ}_{1}^{k} ( {r}_{1}^{j} ) & ⋯ & {Γ}_{{N}_{k , k + 1}}^{k} ( {r}_{1}^{j} ) \\ ⋮ & ⋱ & ⋮ \\ {Γ}_{1}^{k} ( {r}_{{N}_{j , j + 1}}^{j} ) & ⋯ & {Γ}_{{N}_{k , k + 1}}^{k} ( {r}_{{N}_{j , j + 1}}^{j} )\end{matrix} )$$
rᵢ^{j} labels an i-th point of Rv that belongs to the j-th embedded surface; wherein magnitudes E_{N∞}(ω) are evaluated from expressions expressed as:
$${E}_{N ∞} ( r , ω ) = - \frac{{iωμ}_{0}}{4 π} {\sum }_{n = 1}^{{N}_{N , N + 1}} {n}_{n} \times {H}_{p} \cdot {ℒ}_{n} ( r )$$
wherein Hₚ is a primary magnetic field generated by a Tx coil
with:
$${ℒ}_{n} ( r ) = {\int }_{{Δ}_{n}^{N}} \frac{d r}{\vert r - {r}^{′} \vert}$$
calculating a magnetic sensitivity kernel in each compartment of E(r) an IPHC by using a reciprocity theorem expressed as:
$${S}_{j} ( r ) = - \frac{1}{{N}_{{T}_{x}} {I}_{TX}} {E}_{j}^{p} ( r )$$
where Eⱼ^{p}(r) is given by:
$$4 π {E}_{j}^{p} ( {r}_{s} ) = 4 π {E}_{∞} ( {r}_{s} , ω ) + {\sum }_{k = 1}^{N - 1} \frac{( {σ}_{k + 1} - {σ}_{k} )}{{σ}_{k + 1}} {\sum }_{n = 1}^{{N}_{k , k + 1}} {M}_{n}^{k} ( {r}_{s} ) {E}_{est}^{k}$$
and
Eₑₛₜ^{k}=(D+M)⁻¹E_{∞N}.
